(19) United States
(12) Patent Application Publication
(10) Pub. No.: US 2023/0249280 A1
(43) Pub. Date: Aug. 10, 2023

(54) HARD DISK DRIVE ENCLOSURES

(71) Applicant: Seagate Technology LLC, Fremont, CA (US)

(72) Inventors: Samuel E. Severson, Longmont, CO (US); Jeffrey L. Bruce, Longmont, CO (US); Stephen G. Horning, Longmont, CO (US); Hassan Rezayat, Longmont, CO (US)

(21) Appl. No.: 17/666,819

(22) Filed: Feb. 8, 2022

(51) Int. Cl. B23K 20/12

(52) U.S. Cl. CPC B23K 20/1255; B23K 20/129; B23K 2101/36

(57) ABSTRACT

A method for attaching a cover to a base includes coupling the cover to the base and welding the cover to the base using a friction stir welding tip. The method further includes pushing the cover against the base using a shoulder through which the friction stir welding tip extends.

### SUMMARY

In certain embodiments, a tool assembly includes a welding tip that is a rotatable friction stir welding tip and a shoulder that at least partially surrounds the welding tip and is arranged to contact a workpiece.

In certain embodiments, a method for attaching a cover to a base is described. The method includes coupling the cover to the base and welding the cover to the base using a friction stir welding tip. The method further includes pushing the cover against the base using a shoulder through which the friction stir welding tip extends.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 shows a perspective exploded view of a hard disk drive, in accordance with certain embodiments of the present disclosure.

FIG. 2 shows a simplified schematic of a side cutaway view of a portion of a hard disk drive, in accordance with certain embodiments of the present disclosure.

FIG. 3 shows a simplified schematic of a side cutaway view of another portion of the hard disk drive of FIG. 2, in accordance with certain embodiments of the present disclosure.

FIG. 4 shows a perspective view of a tool, in accordance with certain embodiments of the present disclosure.

FIGS. 5 and 6 show different views of a welding tip and press footer, in accordance with certain embodiments of the present disclosure.

FIG. 7 shows another example of a welding tip and press footer, in accordance with certain embodiments of the present disclosure.

FIG. 8 shows a block diagram representation of a method for making a hard disk drive, in accordance with certain embodiments of the present disclosure.

While the disclosure is amenable to various modifications and alternative forms, specific embodiments have been shown by way of example in the drawings and are described in detail below. The intention, however, is not to limit the disclosure to the particular embodiments described but instead is intended to cover all modifications, equivalents, and alternatives falling within the scope of the appended claims.

### DETAILED DESCRIPTION

Hard disk drives can be filled with air and a lower density gas, such as helium, and sealed to control and maintain the internal environment of the hard disk drives. For example, hard disk drives can include a base deck and a cover that are coupled together to form a sealed, enclosed internal cavity. One approach for coupling base decks and covers together is to weld the parts to each other. However, some portions of the base decks and/or covers may be relatively thin and therefore are more likely to deform during welding such that the base decks and/or covers do not meet dimensional or visual inspection requirements. Certain embodiments of the present disclosure are directed to reducing the risk of deforming hard disk drive components during welding.

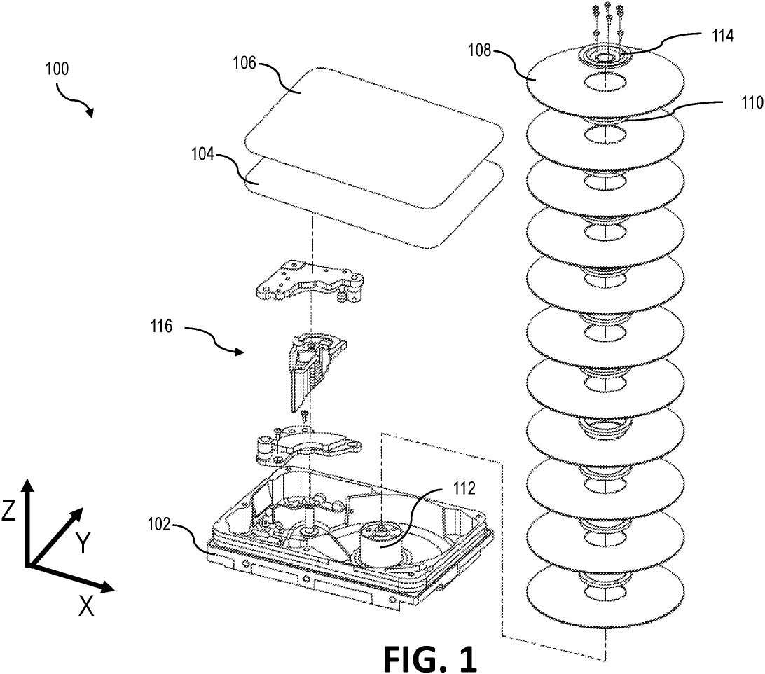

FIG. 1 shows an exploded view of a hard disk drive 100, which can include a base deck 102 (sometimes referred to as a baseplate), a process cover 104, and a top cover 106. The process cover 104 can be coupled to the base deck 102 to create an internal cavity that houses data storage components like magnetic recording media 108 (eleven of which are shown in FIG. 1 and which are sometimes referred to herein as disks), disk spacers 110 (ten of which are shown in FIG. 1) positioned between adjacent magnetic recording media 108, a spindle motor 112, a disk clamp 114, and an actuator assembly 116. Although eleven individual disks are shown in FIG. 1, the hard disk drive 100 could include a different number of disks. As just an example, the hard disk drive 100 could include ten disks or twelve disks. Smaller form-factor hard disk drives can have fewer disks such as 2-4 disks.

During assembly, the process cover 104 can be coupled to the base deck 102 by removable fasteners to seal a target gas (e.g., air with nitrogen and oxygen and/or a lower-density gas like helium) within the internal cavity. Once the process cover 104 is coupled to the base deck 102, a target gas may be injected into the internal cavity through an aperture in the process cover 104. Injecting the target gas, such as a combination of air and a low-density gas like helium (e.g., with the target gas including 90 percent or greater helium), may involve first evacuating existing gas from the internal cavity and then injecting the target gas from a low-density gas supply reservoir into the internal cavity.

Once the process cover 104 is sealed and the target gas injected, the hard disk drive 100 can be subjected to a variety of processes and tests. Example processes and tests include those that establish performance parameters of the hard disk drive 100 (e.g., fly-height parameters), that identify and map flaws on the magnetic recording media, that write servo and data patterns on the magnetic recording media, and that determine whether the hard disk drive 100 is suitable for commercial sale. Once the hard disk drive 100 has passed certain processes and tests, the base deck 102 and the top cover 106 can be coupled together by welding. In embodiments where air-instead of helium-is the target gas, the hard disk drive 100 may only have a top cover and it may be coupled to the base deck with fasteners and a sealing gasket.

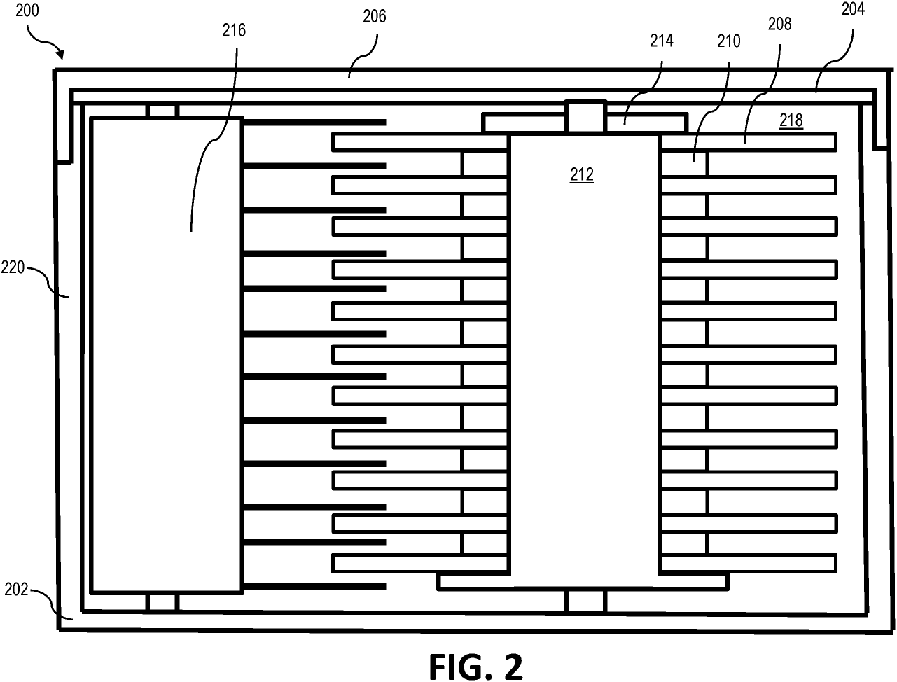

To help explain certain space constraints of hard disk drives such as the hard disk drive 100 of FIG. 1, FIG. 2 shows a simplified schematic of a hard disk drive 200. It is noted that the features and dimensions of the hard disk drive 200 of FIG. 2 described below could be used with the hard disk drive 100 of FIG. 1 and vice versa. The relative dimensions of the components shown in FIG. 2 are not necessarily to scale. For illustrative purposes, the hard disk drive 200 can be a 3.5” form factor hard disk drive, which can be at least partially filled with air and/or a low density gas such as helium, however, hard disk drives designed as 2.5” form factors can utilize features and processes described herein.

The hard disk drive 200 includes a base deck 202, a process cover 204, a top cover 206, magnetic recording media 208, disk spacers 210, a spindle motor 212, a disk clamp 214, and an actuator assembly 216. The base deck 202 and the process cover 204 form an enclosure with an internal cavity 218.

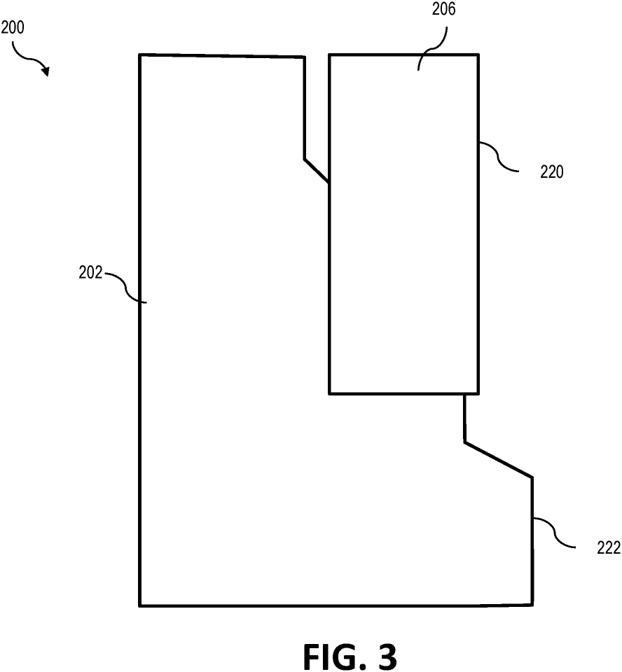

The top cover 206 can be shaped to fit onto the base deck 202 like a lid for a shoebox. Sidewalls 220 of the base deck 202 can be shaped such that the top cover 206 can fit over the base deck 202 without extending past an outermost surface of the base deck 202. For example, a top portion of the sidewalls 220 can include a notch or recess that is large enough for bottom portions of the top cover 206 to fit within. These features are shown in more detail in FIG. 3, described further below.

The space within the internal cavity 218 along a height (e.g., a height between a floor of the base deck 202 and the process cover 204) can be consumed by the magnetic recording media 208, the disk spacers 210, parts of the spindle motor 212, the disk clamp 214, and parts of the actuator assembly 216 among other items. Therefore, the thicknesses of these components can affect the number of disks of the magnetic recording media 208 that can fit within the internal cavity 218. Further, reducing the thickness of the process cover 204 and the top cover 206 (and base deck 202) can increase the space available for the magnetic recording media 208.

As such, to increase the space available to fit more magnetic recording media 208 (without increasing the overall outer dimensions of the hard disk drive 200), the thicknesses of the various components can be decreased. Certain embodiments of the present disclosure disclose systems, methods, and devices for decreasing the thickness of top covers welded to base decks.

FIG. 3 shows a close-up view of the base deck 202 and top cover 206, where the top cover 206 directly contacts a sidewall of the base deck 202. The base deck 202 has a recess that is deep enough for a thickness of the top cover 206 to fit. For example, an outermost surface 220 of the top cover 206 does not extend past an outermost surface 222 of the base deck 202. As such, the outermost surface 222 of the base deck 202 defines the outermost surface of the hard disk drive 200.

In certain embodiments, the thickness of top cover (e.g., the top cover 106/206) that is welded to the base deck 102/202 is no more than 0.010” (0.25 mm). As noted above, using a thinner top cover creates more space within the hard disk drive 100/200 so that additional space is created for fitting more disks into the hard disk drive-without increasing the overall external size of the hard disk drive.

However, welding a thin top cover to a base deck can be challenging. One challenge involves deforming the top cover during welding. For example, when using a friction stir welding approach, the top cover can deform under force of the welding tip and can bow. This deformation can create leaks paths and/or lead to visual defects. Because welding the top cover is one of the last of many processes for manufacturing hard disk drives, deformation during welding can be a costly error. Certain embodiments of the present disclosure describe tools for helping to reduce the risk of deformation of top covers.

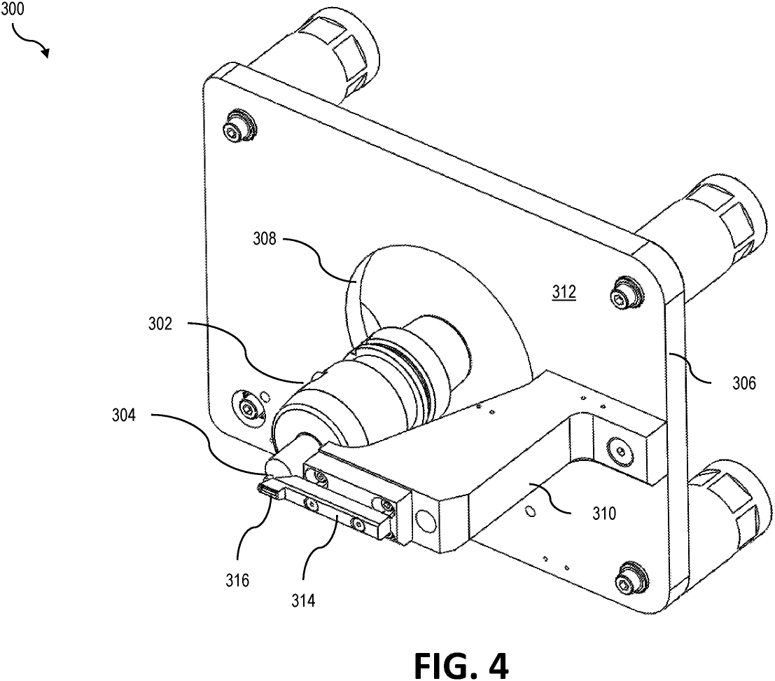

FIG. 4 shows a tool assembly 300 including a welding tool 302 and a welding tip 304. The welding tool 302 can include a chuck for removably coupling the welding tip 304 such that the welding tip 304 can be replaced from time to time. The welding tool 302 and the welding tip 304 can rotate. In certain embodiments, the welding tool 302 is coupled to a motor/transmission system that controls the rotation speed of the welding tool 302 (and therefore the welding tip 304 too). The welding tip 304 is described below in more detail.

The tool assembly 300 also includes a support structure 306. The support structure 306 can be a table-like structure. In FIG. 4, the support structure 306 defines an opening 308 through which the welding tool 302 extends through. Attached to the support structure 306 is a leg 310. The leg 310 extends from a top surface 312 of the support structure 306. One or more fasteners (e.g., bolts) can be used to couple the leg 310 to the support structure 306.

Attached to the bottom of the leg 310 is a foot 314. The foot 314 can be removably coupled to the leg 310 via fasteners such that the foot 314 can be replaced from time to time. The foot 314 includes a presser foot portion 316 (hereinafter “the presser foot 316”). As will be described in more detail below, the presser foot 316 acts as a material constraint device and provides a force on a work piece-such as a hard disk drive and its base deck and cover—to limit movement and deformation of the work piece during welding.

In certain embodiments, the presser foot 316 is positioned at a distal end of the foot 314. In certain embodiments, the presser foot 316 is part of the foot 314 (as opposed to being a separate removable part), although the foot 314 and the presser foot 316 could be made from different parts and coupled together.

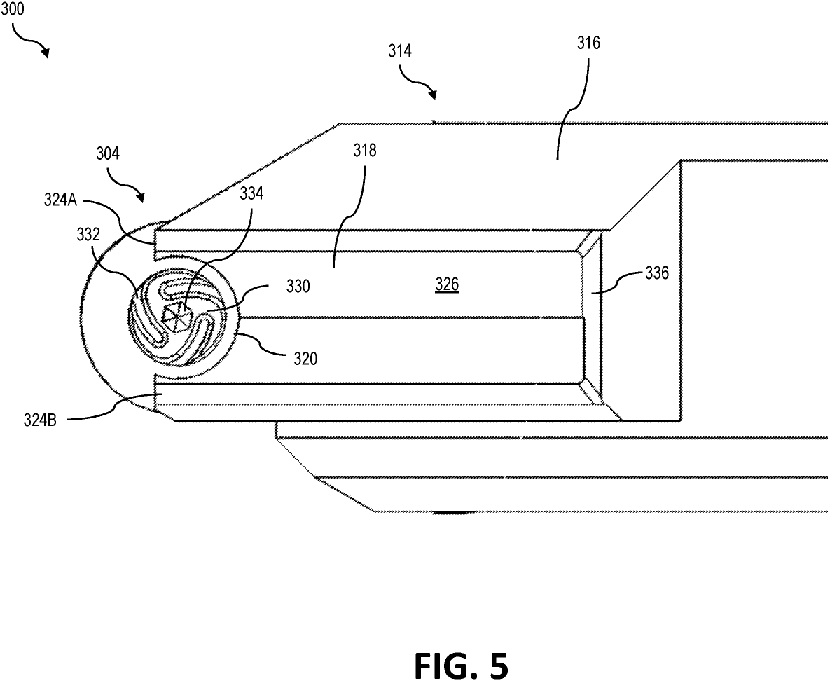

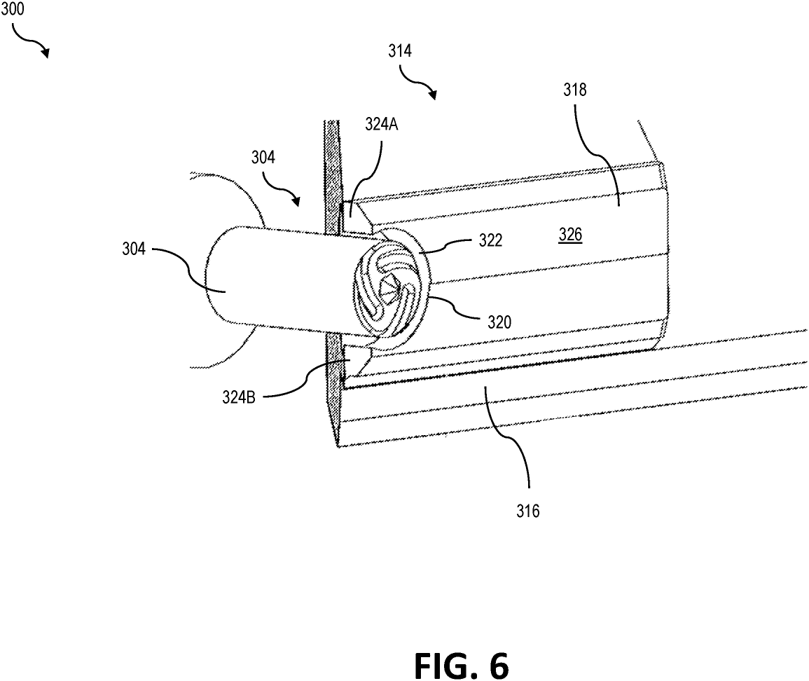

FIGS. 5 and 6 show a closer-up view of the tool assembly 300 near the distal ends of the welding tip 304 and the foot 314. As shown in both figures, the welding tip 304 is at least partially surrounded by the presser foot 316. For example, the presser foot 316 can include a shoulder 318 (e.g., a raised shoulder) that includes an opening 320 through which the welding tip 304 extends.

The opening 320 can be circular shaped with a slightly larger circumference than the welding tip 304 such that the welding tip 304 can fit within the opening 320 with a gap between the welding tip 304 and the foot 314. In certain embodiments, the gap is 0.002-0.003” (e.g., 0.0025”) wide.

The opening 320 can be defined by an inner surface 322 (shown in FIG. 6), which faces an outer surface of the welding tip 304. In certain embodiments, the inner surface 322 surrounds 50-70% (e.g., 50-60%, 55-65%) of outer circumference of the welding tip 304. For example, the inner surface 322 can define a “C″-shape profile. As such, the presser foot 316 can include two toes 324A and 324B that extend around the opening 320 and define distal ends of the presser foot 316. The distance between the toes 324A and 324B at their distal end can be greater than the diameter of the welding tip 304. The presser foot 316 (e.g., the shoulder 318 portion of the presser foot 316) includes one or more outer surfaces 326 which are arranged to contact a workpiece during welding.

FIG. 5 includes reference numbers for various features of the welding tip 304. The welding tip 304 includes a distal face or end face 330. The welding tip 304 also includes grooves 332 within the end face 330. The grooves 332—three of which are shown in FIG. 5—are arcuate shaped and extend from the outer perimeter inwards. In certain embodiments, the grooves 332 have a depth ranging 0.05 to 0.5 millimeters relative to the surface of end face 330. Sidewalls of the grooves 332 can be curved or angled relative to a central longitudinal axis of the welding tip 304, i.e., not parallel to the longitudinal axis.

In certain embodiments, the end face 330 is positioned within the opening 320 of the presser foot 316 such that the end face 330 extends along a plane that intersects the inner surface 322. In other embodiments, the end face 330 is positioned past the opening 320 of the presser foot 316 such that the end face 330 extends along a plane that intersects the inner surface 322

A pin 334 extends from the end face 330 in a direction along the central longitudinal axis of the welding tip 304 and distally from end face 330. The pin 334 can have multiple outer surfaces (e.g., sidewalls) that include three or more facets (six are shown in FIG. 5), which are flat or planar surfaces that are oriented to be non-parallel to the longitudinal axis. Facets may be connected to adjacent facets or may optionally be interrupted by rounded portions. Distal pin end (e.g., the portion of pin 334 that is farthest away from end face 330) of the pin 334 can be flat and planar or may be cornered, angular, or substantially sharp (e.g., formed by an intersection of the facets, as shown in FIG. 5) such that distal pin end forms a center point at the middle of the welding tip 304. The distal pin end extends past the surface 326 (e.g., the workpiece-facing surface) of the shoulder 318.

As noted above, the base deck 102/202 and the top cover 106/206 of the hard disk drive 100/200 can be welded together. The tool assembly 300 is used to weld the base deck and the top cover together. In particular, the welding tip 304 creates a weld path along where the base deck and the top cover are positioned adjacent to each other (e.g., along a joint of the base deck and the top cover). The welding tip 304 can be considered to be a friction stir weld tip.

To weld the top cover to the base deck, the welding tip 304 is rotated and pressed against the hard disk drive with a relatively large force in a direction along the longitudinal axis of the welding tip 304. In certain embodiments, the welding tip 304 is rotated at speeds such as 1,000-30,000 revolutions per minute (rpm) (e.g., at least 2,000, 6,000, 8,000, or 12,000 rpm, and up to about 30,000 rpm). Examples of a downforce may be less than about 1,000 newtons (e.g., 100-500 Newtons).

While the welding tip 304 is rotated and pressed against the hard disk drive, the welding tip 304 is moved or translated along a weld path along the joint of the base deck and the top cover. Examples translational speeds can be in a range 0.1-3 meters per minute and more specifically, 1.5-50 millimeters per second.

During this process, the welding tip 304 mechanically mixes together the material (e.g., metal) of the base deck and the top cover. The welding tip 304 may heat (e.g., via friction) and soften metal of the base deck and the top cover without necessarily melting the metal. In certain embodiments, the metals of the base deck 102 and the top cover 106 are dissimilar. For example, the base deck 102 can comprise aluminum and the top cover 106 can comprise steel. The diameter of the welding tip 304 dictates the height of the weld path when the welding tip 304 is used for only a single pass. In certain embodiments, the welding tip 304 has a diameter of 1-4 mm (e.g., 1.5 mm, 2 mm, 2.5 mm, 3 mm).

As noted above, the top cover, in particular, may be relatively thin (e.g., on the order of 0.01” or 0.25 mm thick). Thin work pieces can be challenging to weld without unwanted deformation such as bowing, which can lead to leaks and ridges that can be seen and felt. To help mitigate the risk of unwanted deformation, the tool assembly 300 uses the presser foot 316 to constrain the workpiece.

The presser foot 316 is arranged to contact the workpiece (e.g., the hard disk drive, and particularly, the base deck and the top cover) during welding. The shoulder 318 (e.g., the workpiece-facing outer surface(s) 326) of the presser foot 316 exerts a force on the thin top cover such that the top cover is constrained and is less likely to deform. This exerted force constrains the top cover from bowing out.

The shoulder 318 can contact the workpiece at a section that has not yet been welded by the welding tip 304 to help position the top cover to the base deck. For example, the shoulder 318 may include a leading chamfer 336 that makes initial contact with the top cover and/or base deck as the hard disk drive is translated relative to the welding tip 304. During and after a given section of the workpiece has been welded, the shoulder 318 can continue to apply pressure against the workpiece (until the workpiece passes the length of the should 318) to constrain the top cover against the base deck such that it is less likely to deform and bow.

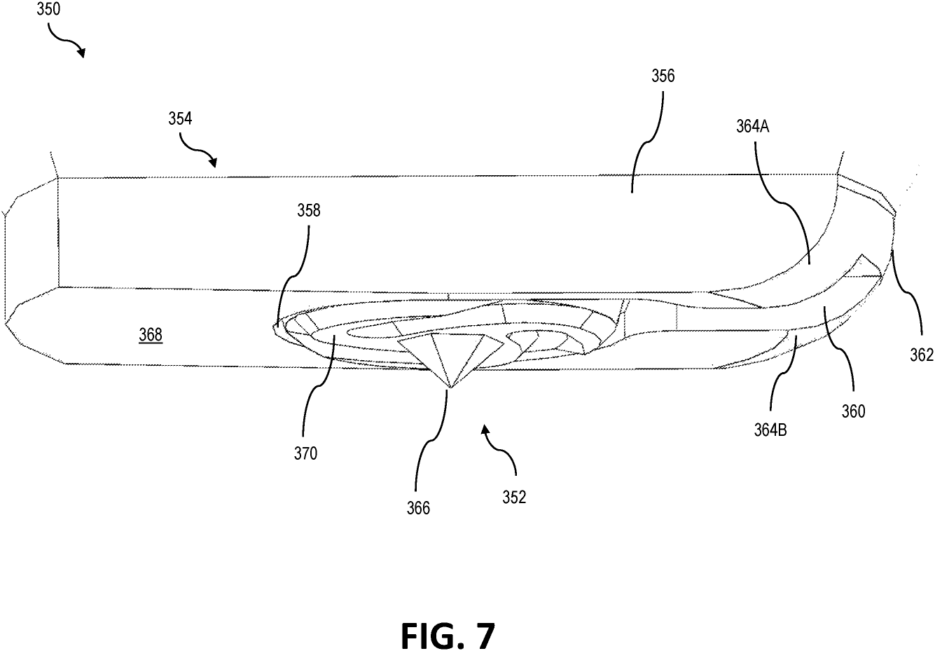

FIG. 7 shows another example of a tool assembly’s 350 welding tip 352 and press footer 354. The press footer 354 includes a shoulder 356 with a circular-shaped opening 358 and a channel 360 extending between the opening 358 and a trailing edge 362 of the shoulder 356.

The trailing edge 358 of the shoulder 356 includes a rounded section. For example, the trailing edge 358 can include a first rounded edge 364A and a second rounded edge 364B on opposite sides of the channel 360. The trailing edge can assist with positioning the workpiece (e.g., the top cover against the base deck) before, during, or after the workpiece is welded together.

As shown in FIG. 7, the welding tip 352 extends through the opening 358. For example, the welding tip 352 can include a distal tip 366 that extends past the press footer 354 (e.g., past a workpiece-facing surface 368 of the press footer 354). As another example, an end face 370 of the welding tip 352 can extend past the workpiece-facing surface 368 of the press footer 354.

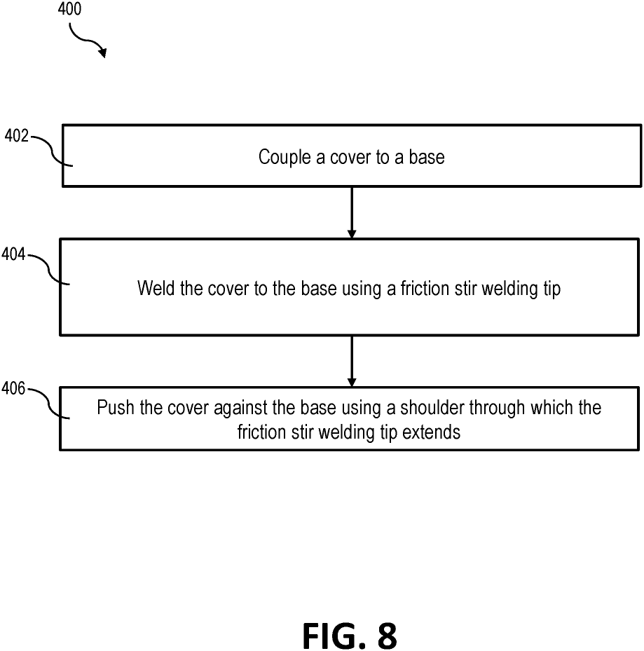

FIG. 8 shows an illustrative method 400 for assembling a base deck to a top cover. The method 400 includes coupling the top cover to the base deck (block 402 in FIG. 8). The method 400 further includes welding the top cover to the base deck using a friction stir welding tip (block 404 in FIG. 8). The method 400 further includes pushing, using a shoulder through which the friction stir welding tip extends, the top cover to the base deck (block 406 in FIG. 8).

Various modifications and additions can be made to the embodiments disclosed without departing from the scope of this disclosure. For example, while the embodiments described above refer to particular features, the scope of this disclosure also includes embodiments having different combinations of features and embodiments that do not include all of the described features. Accordingly, the scope of the present disclosure is intended to include all such alternatives, modifications, and variations as falling within the scope of the claims, together with all equivalents thereof.

We claim:

1. A tool assembly comprising:
a welding tip that is a rotatable friction stir welding tip; and
a shoulder at least partially surrounding the welding tip and arranged to contact a workpiece.

2. The tool assembly of claim 1, wherein the shoulder includes an opening, wherein the welding tip extends through the opening.

3. The tool assembly of claim 2, wherein the opening is circular shaped.

4. The tool assembly of claim 1, wherein the opening is defined by an inner surface, wherein the inner surface surrounds 50-70% of an outer circumference of the welding tip.

5. The tool assembly of claim 1, wherein the opening is defined by an inner surface, wherein the inner surface surrounds 50-60% of an outer circumference of the welding tip.

6. The tool assembly of claim 1, wherein the welding tip has a proximal end and a distal end, wherein the distal end is defined by a center point.

7. The tool assembly of claim 6, wherein the center point extends past a workpiece-facing surface of the shoulder.

8. The tool assembly of claim 7, wherein the welding tip includes an end face, wherein the end face is positioned within an opening of the shoulder.

9. The tool assembly of claim 7, wherein the welding tip includes an end face, wherein the end face also extends past the workpiece-facing surface.

10. The tool assembly of claim 1, wherein the shoulder includes a circular-shaped opening and a channel extending between the opening and a leading edge of the shoulder.

11. The tool assembly of claim 10, wherein the welding tip extends through the opening.

12. The tool assembly of claim 10, wherein the shoulder includes a rounded section on the leading edge.

13. The tool assembly of claim 10, wherein the shoulder includes a first rounded edge and a second rounded edge on opposite sides of the channel.

14. The tool assembly of claim 1, wherein the shoulder is stationary.

15. The tool assembly of claim 1, wherein the shoulder is shaped and positioned to contact the workpiece after the welding tip has welded the workpiece.

16. The tool assembly of claim 1, wherein the shoulder is part of a press footer.

17. The tool assembly of claim 1, wherein the shoulder includes two toe sections that at least partially surround the welding tip.

18. A method for attaching a cover to a base, the method comprising:
coupling the cover to the base;
welding the cover to the base using a friction stir welding tip; and
pushing, using a shoulder through which the friction stir welding tip extends, the cover against the base.

19. The method of claim 18, wherein the cover is pressed against the base before, during, and after the welding.

20. The method of claim 18, wherein the shoulder is stationary.
